(19) United States
(12) Patent Application Publication
(10) Pub. No.: US 2026/0038913 A1
(43) Pub. Date: Feb. 5, 2026

(54) COMPARTMENT FOR ACCOMMODATING A PART CAPABLE OF GIVING OFF HEAT

(71) Applicant: VALEO SYSTEMES THERMIQUES, La Verriere (FR)

(72) Inventors: Kamel AZZOUZ, La Verriere (FR); Jean-Louis LANARD, La Verriere (FR); Sebastien GARNIER, La Verriere (FR); Yolanda BRAVO, Zaragoza (ES)

(73) Assignee: VALEO SYSTEMES THERMIQUES, La Verriere (FR)

(21) Appl. No.: 18/873,217

(22) PCT Filed: May 31, 2023
(86) PCT No.: PCT/EP2023/064488

§ 371 Date: Sep. 8, 2025

(30) Foreign Application Priority Data
Jun. 8, 2022 (FR) FR2205471

(51) Int. Cl. H01M 10/6556; F28F 3/14; H01M 10/613; H01M 10/625; H01M 10/663

(52) U.S. Cl. CPC H01M 10/6556; F28F 3/14; H01M 10/613; H01M 10/625; H01M 10/663; F28F 2275/06; H01M 2220/20

(57) ABSTRACT

The invention relates to a compartment designed to receive a part capable of giving off heat during its operation, in particular the part being an electrochemical energy storage module. The compartment includes a lid, a tray provided with a bottom wall on which the part can be placed, and a side wall designed to be assembled with the lid that closes the tray, the bottom wall and the side wall being in a single piece. The compartment further includes an outer plate which is designed to be assembled on an outer assembly face of the tray or of the lid, in order to form at least one flow channel for a heat transfer fluid.

### TECHNICAL FIELD

The present invention relates to a compartment, arranged to receive a component capable of giving off heat during operation. The invention also relates to a method for manufacturing such a compartment.

The invention relates in particular to a compartment for cooling at least one electrochemical storage module, in particular for the automotive sector.

### BACKGROUND OF THE INVENTION

Electrochemical storage modules, in other words battery modules intended for electric or hybrid vehicles, must, as far as possible, be kept at the desired temperature for optimal operation. For this purpose, temperature regulation devices are used, either to cool or to heat said modules to keep them at a desired temperature. In particular, the temperature regulation devices include a compartment arranged to receive the battery modules.

Patent application DE 10 2015 115 875 A1 describes a device for regulating the temperature of battery modules, provided with a compartment containing the modules. The walls forming the compartment are separate. It is thus necessary to assemble them in several stages.

### SUMMARY OF THE INVENTION

The invention aims to simplify the design and manufacture of the compartment.

The invention thus proposes a compartment arranged to receive a component capable of giving off heat during operation, this component being in particular an electrochemical energy storage module, the compartment comprising:
a cover;
a tray provided with a bottom wall on which the component can be placed and a side wall which is arranged to be assembled with the cover that closes the tray, the bottom wall and the side wall being in one piece; and
an external plate arranged to be assembled on an external assembly face belonging to the tray or to the cover, to form at least one circulation channel for a heat transfer fluid.

Thus, by virtue of the tray, the bottom wall and side wall of which are made in one piece, the number of elements and the number of operations necessary to manufacture the compartment are reduced. The manufacture of the compartment becomes simpler. The production cost of the compartment is thus reduced.

Furthermore, the fact that a smaller number of elements is required to assemble the tray reduces the risk of infiltration (e.g. dust, liquids) coming from outside the compartment. Sealing of the compartment is thus improved, in particular, by virtue of the tray, the bottom wall and side wall of which are made in one piece. The one-piece tray also has the advantage of eliminating the need for joining materials (for example, adhesive, gum, silicone) and thus reducing the weight of the compartment.

According to one aspect of the invention, the bottom wall comprises a flat internal face on which the component can be placed.

Thus, the contact surface between the component and the bottom wall is maximized such that heat exchange between the bottom wall and the component is optimized.

According to one aspect of the invention, the external assembly face is on the bottom wall or on the side wall or on the cover.

According to one aspect of the invention, when the external plate is on the external assembly face, this external assembly face is arranged to allow heat exchange between the component and the heat transfer fluid.

According to one aspect of the invention, the external plate comprises a plurality of recessed areas forming a plurality of channels, for example two circulation channels parallel to one another.

According to one aspect of the invention, the external plate comprises flat junction areas, in particular between the recessed areas, these flat junction areas being arranged to be pressed against the external assembly face to form the circulation channel(s).

According to one aspect of the invention, the circulation channels, in cross section, have a straight edge on the recessed area, which straight edge is opposite the external assembly face. Each channel is formed by the external assembly face and the external plate which each define a portion of the transverse perimeter of the channel.

According to one aspect of the invention, the circulation channel is in communication with a fluid inlet and a fluid outlet.

According to one aspect of the invention, the circulation channels have a common inlet and outlet.

Thus, the common inlet and outlet simplify the channel design. Alternatively, the inlet and outlet are formed on a ledge belonging to the tray.

According to one aspect of the invention, each circulation channel comprises a plurality of turns.

According to one aspect of the invention, at least one of the circulation channels has a U-shaped portion.

According to one aspect of the invention, the two parallel channels each have a U-shaped portion, one of the U-shaped portions being inside the other U-shaped portion.

Thus, the presence of a plurality of turns created by the channel maximizes the surface area for exchange between the heat transfer fluid and the component, so as to thereby optimize heat exchange.

According to one aspect of the invention, the channels take up at least 50% of the surface area of the external plate, preferably at least 80% of the surface area of the external plate.

According to one aspect of the invention, the channels are symmetrical about a plane which perpendicularly intersects the plane of the external assembly face.

According to one aspect of the invention, the circulation channels of the external plate are produced by stamping.

Thus, stamping simplifies the manufacture of channels.

According to one aspect of the invention, the heat transfer fluid is a refrigerant fluid, in particular a fluid selected from the refrigerant fluids R134a, R1234yf and R744.

According to one aspect of the invention, the heat transfer fluid is itself cooled by an evaporation exchanger (referred to as a chiller) connected to an air conditioning loop of the vehicle.

According to one aspect of the invention, each external assembly face or external plate is provided with at least one disrupting element disrupting the flow of the heat transfer fluid, said disrupting elements protruding from the face intended to be in contact with the fluid.

According to one aspect of the invention, the at least one recessed area is provided with at least one disrupting element.

According to one aspect of the invention, at least one of the disrupting elements has a circular, oval, ogival or chevron shape.

These shapes of the disrupting elements are intended to create a type of fluid flow in which a turbulent movement of the fluid is created, so that heat exchange between the fluid and the circulation channel is optimal.

According to one aspect of the invention, the tray is based on a metal.

According to one aspect of the invention, the external plate is based on a metal.

The metal is selected from aluminum, aluminum alloy, aluminum foam or steel, preferably aluminum alloy containing magnesium.

The metal tray or metal external plate has sufficient rigidity to ensure good mechanical protection.

Since metal is a good conductor, when the component is placed, in particular on a flat internal face of the tray, it is not necessary to apply a conduction element such as thermal paste.

In particular, aluminum alloy containing magnesium provides good machinability for producing complex elements and good resistance to creep at high temperature, compared to conventional aluminum.

According to one aspect of the invention, the tray is based on a composite or plastic.

This makes the tray more lightweight while maintaining optimal mechanical characteristics.

According to one aspect of the invention, the external plate is based on a composite or plastic.

This makes the plate more lightweight while maintaining optimal mechanical characteristics.

The composite comprises a polymer matrix loaded with reinforcing elements such as carbon or glass fibers.

The polymer matrix is a thermoplastic such as ABS, PMMA, PE, PVC, PET, PP, PVC.

The plastic is a thermoplastic such as ABS, PMMA, PE, PVC, PET, PP, PVC.

Provision can be made for the external assembly face to be made of metal and the external plate made of plastic, being in particular a polymer-based composite.

Provision can be made for the external assembly face and the external plate to be made of plastic, being in particular a polymer-based composite.

Provision can be made for the external assembly face to be made of metal and the external plate made of metal.

Provision can be made for the external assembly face and/or the external plate to be made of aluminum, preferably aluminum alloy containing magnesium.

According to one aspect of the invention, the tray is produced by stamping.

This manufacturing technique is suitable for forming the tray, the bottom wall and side wall of which are made in one piece.

According to one aspect of the invention, the internal face of the side wall is provided with a recess arranged to receive the component.

Thus, this recess allows the component to be immobile during transport. The component can be provided with a securing means such as a tab interacting with the recess.

According to one aspect of the invention, the cover further comprises at least one recessed protrusion that is recessed relative to the main plane of the cover.

The recessed protrusion thus makes it possible to immobilize the component during transport. The recessed protrusion is advantageous in that it keeps the weight of the cover the same.

According to one aspect of the invention, the side wall of the tray comprises a rim extending outwardly from the side wall.

According to one aspect of the invention, the rim is provided with at least one hole.

According to one aspect of the invention, the cover is provided with at least one hole arranged to interact with the hole in the rim of the side wall.

Thus, the holes are, for example, intended for conventional mechanical assembly methods, such as screwing or riveting, in order to attach the cover sealingly relative to the tray. Other methods such as welding or adhesive bonding can be used.

According to one aspect of the invention, the perimeter of the bottom wall of the tray has the shape of a polygon, in particular rectangular.

According to one aspect of the invention, the perimeter of the bottom wall of the tray has the shape of a circle, an oval, or an ellipsoid.

According to one aspect of the invention, the assembly of the external plate and the external assembly face is carried out by a method selected from adhesive bonding, welding, rolling and riveting.

In particular, welding and adhesive bonding have the advantage of not affecting the rigidity of the materials to be assembled.

According to one aspect of the invention, the welding method is MIG (metal inert gas)-MAG (metal active gas) welding.

According to one aspect of the invention, the welding method is laser welding.

According to one aspect of the invention, the side wall is provided with at least one heat transfer fluid circulation area and the compartment comprises at least one tube comprising at least one circulation fluid flow channel, this tube being in fluidic communication with the heat transfer fluid circulation area of the side wall and extending in an interior space of the compartment, in particular between two places for components.

This allows the components to be cooled efficiently thanks to the tube(s) which make it possible to have a larger surface area for heat exchange.

According to one aspect of the invention, the side wall comprises at least one slot arranged to receive, sealingly, one end of the tube in such a way as to provide the fluidic communication between the tube and the heat transfer fluid circulation area of the side wall. This slot facing the inside of the compartment has, for example, an elongate shape along the height of the compartment.

According to one aspect of the invention, the slot in the side wall is bordered by an annular collar which bears, sealingly, on a portion of the tube.

According to one aspect of the invention, the tube has two parallel main faces, in particular two parallel flat faces.

Thus the tube, via these faces, can have extensive thermal contact with the components to be cooled, which improves the thermal efficiency of the assembly.

According to one aspect of the invention, the tube has a height greater than half the height of the side wall.

According to one aspect of the invention, the tube has a height less than the height of the side wall.

According to one aspect of the invention, the tube comprises several internal longitudinal cavities for the flow of heat transfer fluid, defining a plurality of channels.

According to one aspect of the invention, the tube is straight.

According to one aspect of the invention, the side wall comprises two opposite edges, in particular parallel, and the tube extends between these two opposite edges.

According to one aspect of the invention, the compartment comprises a plurality of tubes, in particular arranged parallel. Thus, the side wall can be provided with two rows of slots, on two opposite faces of the side wall, each tube interacting with two opposite slots.

According to one aspect of the invention, these tubes are placed between places for receiving the components to be cooled.

Thus, on either side of the tubes, there are components to be cooled.

According to one aspect of the invention, the component is cooled by two tubes arranged on either side of this component.

The invention thus makes it possible to cool the components on two opposite faces of the latter.

According to one aspect of the invention, the tubes are of identical length.

According to one aspect of the invention, the tubes are profile sections, in particular made of aluminum or steel.

According to one aspect of the invention, the compartment comprises two heat transfer fluid circulation areas, one of the areas being an area where fluid enters the tube(s) and the other of the areas being a fluid outlet area for discharging the fluid that has circulated in the tube(s).

According to one aspect of the invention, these two areas are on two opposite faces of the compartment.

The invention also relates to an assembly comprising at least one component, in particular at least one electrochemical energy storage module, and a compartment according to the invention, arranged to exchange heat with this component placed on the internal face of the thermal regulation compartment.

The component can be an electrochemical energy storage module, in particular a battery module, comprising one or more battery cells, in particular housed in a housing. The compartment can receive one or more modules. The modules can be arranged in the compartment in one row or in several parallel rows.

Each row comprises, for example, six modules. The compartment comprises, for example, two rows of six modules, such that a total of twelve modules are housed in this compartment. Each module can be secured in the compartment using securing elements such as screws. Each module has, for example, a rectangular perimeter. Alternatively, this perimeter can be oval or circular.

Multiple battery modules form a battery pack. The packs are distributed in the floor of the vehicle.

According to one aspect of the invention, the component is an electrochemical energy storage module which is selected from battery modules of Li-ion, Li-air, Lithium polymer, Lithium sulfur, Lithium metal, Na-ion, Na-air, K-ion, Mg-ion, or Zn-air type.

According to one aspect of the invention, the component is a fuel cell.

Alternatively, it is possible to provide for a fuel cell, in particular of PEMFC (proton exchange membrane fuel cell) type, to be housed in the compartment instead of battery modules.

According to one aspect of the invention, the component has a cylindrical, prismatic, rectangular, square, or hexagonal shape.

The shape of the compartment and that of the component are chosen such that a maximum number of components can be stored in the compartment with a given volume.

The invention also relates to a method for manufacturing a compartment of the invention, comprising the following step:
shaping a sheet to obtain the bottom wall and the side wall in one piece.

Thus, the bottom wall and the side wall of the tray are made in one piece.

According to one aspect of the invention, the bottom wall and the side wall being made of metal, the method comprises the following step:
shaping the sheet which is made of metal, by stamping, to obtain the bottom wall and the side wall in one piece.

According to one aspect of the invention, the method comprises a step of forming on the external plate a plurality of recessed areas forming a plurality of channels, for example two circulation channels parallel to one another.

According to one aspect of the invention, the method comprises a step of forming flat junction areas between the recessed areas.

According to one aspect of the invention, the method comprises a step of assembling the external plate on the external assembly face, this assembly step being carried out by adhesive bonding, welding, rolling or riveting.

In particular, welding and adhesive bonding have the advantage of not affecting the rigidity of the materials to be assembled.

According to one aspect of the invention, the assembly step is carried out by MIG (metal inert gas)-MAG (metal active gas) welding.

According to one aspect of the invention, the assembly step is carried out by laser welding.

According to one aspect of the invention, the assembly step is preceded by chemical attack or texturing of the external assembly face and/or the flat junction areas of the external plate.

Thus, the chemically attacked or textured surface (hereinafter modified surface) has regular microreliefs making it possible to optimize the angle of contact of the liquid (for example, adhesive) relative to the plane of the surface. For example, in order to improve the quality of adhesive bonding between the external assembly face and flat junction areas of the external plate, the modified surface can have regular patterns such that there is low surface tension of the droplet of liquid (i.e. a small angle of contact relative to the surface). Such a surface modification can also be applied to improve welding between the two metal surfaces.

According to one aspect of the invention, the external assembly face is made of metal and the external plate is made of plastic, being in particular a polymer-based composite.

According to one aspect of the invention, the method further comprises a step of heating and deforming the metal external assembly face.

For the manufacturing method, provision can be made for the external assembly face and the external plate to be made of plastic, being in particular a polymer-based composite.

For the manufacturing method, provision can be made for the external assembly face to be made of metal and the external plate made of metal.

For the manufacturing method, provision can be made for the external assembly face and/or the external plate to be made of aluminum, preferably aluminum alloy containing magnesium.

### BRIEF DESCRIPTION OF DRAWINGS

Further features and advantages of the invention will become more clearly apparent from reading the following description, which is provided by way of non-limiting illustration, and from the appended drawings, in which:

FIG. 1 schematically depicts a perspective view of an assembly according to the invention comprising a cover and a tray;

FIG. 2 schematically depicts a perspective view of the assembly of FIG. 1 without the cover, provided with components;

FIG. 3 schematically depicts a perspective view of the tray without the components;

FIG. 4 schematically depicts a view from below of the compartment;

FIG. 5 schematically and partially depicts a perspective view of an external plate assembled on an external assembly face belonging to the tray, thus forming circulation channels for a heat transfer fluid;

FIG. 6 schematically and partially depicts an enlarged end-on view of FIG. 5, clearly showing the directions of circulation of a heat transfer fluid intended to circulate in the circulation channels according to a first embodiment;

FIG. 7 schematically and partially depicts a view in section of the circulation channels according to a second embodiment;

FIG. 8 schematically and partially depicts a view in section of the circulation channels according to a third embodiment;

FIG. 9 schematically and partially depicts a perspective view of an assembly according to an example of implementation of the invention;

FIG. 10 schematically depicts a view of the assembly of FIG. 9, seen from below;

FIG. 11 schematically depicts a view in section of the compartment of FIG. 9;

FIG. 12 schematically depicts a view of a detail of the compartment of FIG. 9;

FIG. 13 schematically depicts a view of another detail of the compartment of FIG. 9; and

FIG. 14 shows a method according to the invention.

### DETAILED DESCRIPTION OF THE INVENTION

Below, in the drawings, the same numerical references designate the same elements or members.

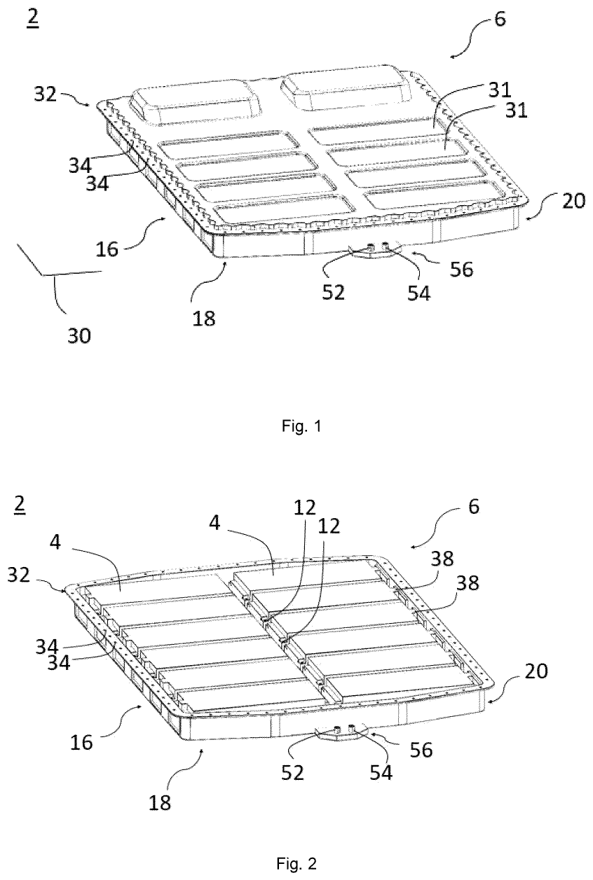

FIGS. 1 and 2 show a perspective view of an assembly 2 comprising components 4 and a compartment 6, arranged to exchange heat with these components 4 placed on an internal face 8 of the compartment 6.

Each component 4 is an electrochemical energy storage module. In particular, each component 4 is a battery module, comprising one or more battery cells housed in a housing.

The electrochemical energy storage module is selected from battery modules of Li-ion, Li-air, Lithium polymer, Lithium sulfur, Lithium metal, Na-ion, Na-air, K-ion, Mg-ion, or Zn-air type.

In the example described, the compartment 6 receives twelve modules, which are arranged in the compartment 6 in two parallel rows.

As can be seen in FIG. 2, each module is secured in the compartment 6 by means of securing elements such as screws 12. Each module has a rectangular perimeter. Alternatively, this perimeter can be oval or circular.

Alternatively, the component 4 is a fuel cell.

In other words, it is possible to provide for a fuel cell, in particular of PEMFC (proton exchange membrane fuel cell) type, to be housed in the compartment 6 instead of battery modules.

As shown in FIGS. 1 and 2, the compartment 6 comprises a cover 14 and a tray 16 provided with a bottom wall 18 on which the component 4 is placed and a side wall 20 which is arranged to be assembled with the cover 14 that closes the tray 16, the bottom wall 18 and the side wall 20 being in one piece.

As can be seen in FIGS. 4, 5 and 6, the compartment 6 further comprises an external plate 22 arranged to be assembled on an external assembly face 24 belonging to the tray 16, to form circulation channels 26 for a heat transfer fluid.

Thus, by virtue of the tray 16, the bottom wall 18 and side wall 20 of which are made in one piece, the number of elements and the number of operations necessary to manufacture the compartment 6 are reduced. The manufacture of the compartment 6 becomes simpler. The production cost of the compartment 6 is thus reduced.

The cover 14 further comprises eight recessed protrusions 31 that are recessed relative to the main plane of the cover 30.

The side wall 20 of the tray 16 comprises a rim 32 extending outwardly from the side wall 20.

The rim 32 is provided with a plurality of holes 34.

The cover 14 is provided with a plurality of holes 34 arranged to interact with the holes 34 in the rim 32 of the side wall 20.

Thus, the holes 34 are, for example, intended for conventional mechanical assembly methods, such as screwing or riveting, in order to attach the cover 14 sealingly relative to the tray 16.

The perimeter of the bottom wall 18 of the tray 16 has a rectangular shape.

The heat transfer fluid is a refrigerant fluid, in particular a fluid selected from the refrigerant fluids R134a, R1234yf and R744.

The heat transfer fluid is itself cooled by an evaporation exchanger (referred to as a chiller, not shown) connected to an air conditioning loop of the vehicle, not shown.

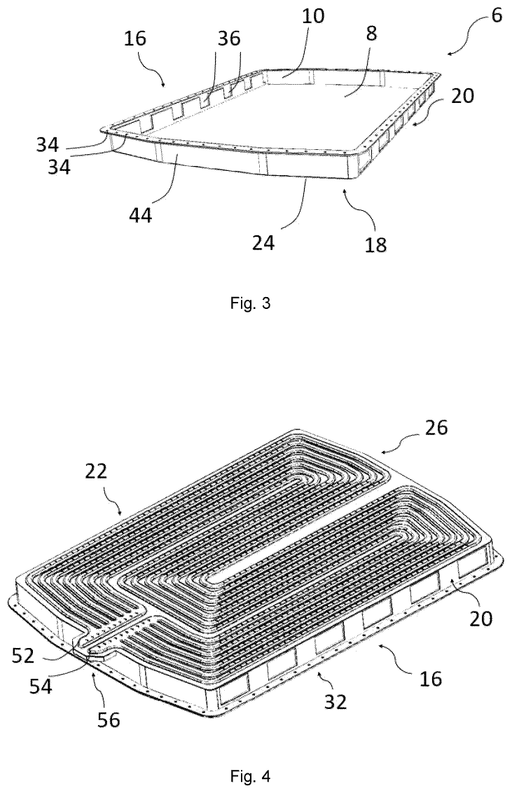

As shown in FIGS. 2 and 3, the bottom wall 18 comprises the flat internal face 8 on which the components 4 are placed.

Thus, the contact surface between the component 4 and the bottom wall 18 is maximized such that heat exchange between the bottom wall 18 and the component 4 is optimized.

As shown in FIG. 3, the internal face 8 of the side wall 20 is provided with a plurality of recesses 36 arranged to receive the components 4.

Thus, these recesses 36 allow the components 4 to be immobile during transport. The components 4 can be provided with securing means such as tabs 38 interacting with the recesses 36.

The external assembly face 24 is on the bottom wall 18 or on the side wall 20 or on the cover 14.

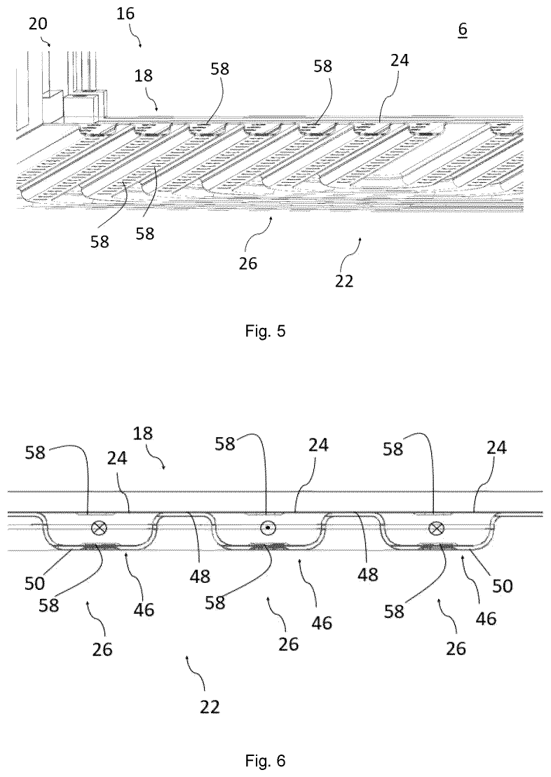

In this example shown in FIGS. 4 and 5, the external assembly face 24 of the bottom wall 18 corresponds to a first embodiment according to the invention.

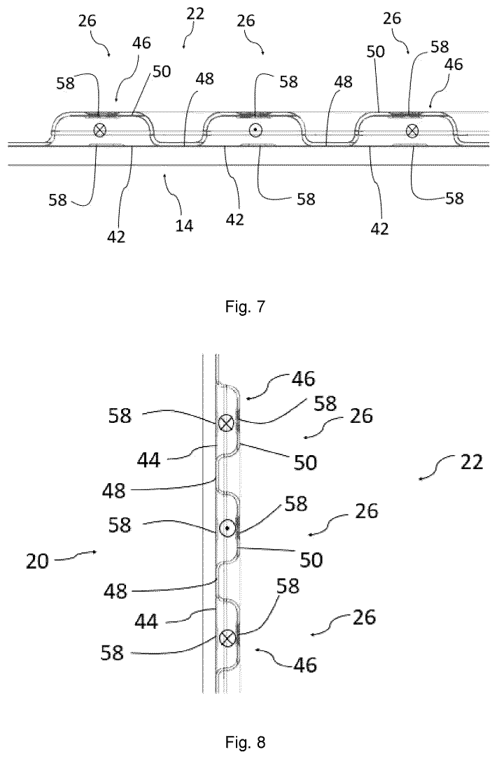

The second and third embodiments are shown in FIGS. 7 and 8, respectively. These two other embodiments respectively concern an external assembly face 42 of the cover 14 or an external assembly face 44 of the side wall 20. The other features describing the first embodiment also apply to the second and third embodiments.

As can be seen in FIGS. 4 to 6, the external plate 22 is on the external assembly face 24 of the bottom wall 18. This external assembly face 24 is arranged to allow heat exchange between the component 4 and the heat transfer fluid.

The external plate 22 comprises a plurality of recessed areas 46 forming a plurality of channels 26, for example two circulation channels 26 parallel to one another.

The external plate 22 comprises flat junction areas 48, in particular between the recessed areas 46, these flat junction areas 48 being arranged to be pressed against the external assembly face 24 to form the circulation channels 26.

The circulation channels 26, in cross section, have a straight edge 50 on the recessed area 46, which straight edge 50 is opposite the external assembly face 24.

Each channel 26 is formed by the external assembly face 24 and the external plate 22 which each define a portion of the transverse perimeter of the channel 26.

The circulation channel 26 is in communication with a fluid inlet 52 and a fluid outlet 54.

As can be seen in FIGS. 1, 2 and 4, the circulation channels 26 have a common inlet 52 and outlet 54.

Thus, the common inlet 52 and outlet 54 simplify the channel design. In this example, these inlet 52 and outlet 54 are formed on a ledge 56 belonging to the tray 16.

Still in the example of FIG. 4, each circulation channel 26 comprises a plurality of turns.

Circulation channels 26 have a U-shaped portion.

In this example, the seven parallel channels 26 each have a U-shaped portion, one of the U-shaped portions being inside the other U-shaped portion.

Thus, the presence of a plurality of turns created by the channels 26 maximizes the surface area for exchange between the heat transfer fluid and the components 4, so as to thereby optimize heat exchange.

The channels 26 are symmetrical about a plane which perpendicularly intersects the plane of the external assembly face 24.

The circulation channels 26 of the external plate 22 are produced by stamping.

As can be seen in FIGS. 5 to 8, each external assembly face 24 or external plate 22 is provided with several disrupting elements 58 disrupting the flow of the heat transfer fluid, said disrupting elements 58 protruding from the face intended to be in contact with the fluid.

As shown in FIGS. 5 to 8, recessed areas 46 are provided with the disrupting elements 58.

In this example, the disrupting elements 58 have a chevron shape.

These shapes of the disrupting elements 58 are intended to create a type of fluid flow in which a turbulent movement of the fluid is created, so that heat exchange between the fluid and the circulation channel 26 is optimal.

The tray 16 is based on a metal.

Advantageously, the external plate 22 is based on a metal.

The metal is selected from aluminum, aluminum alloy or steel, preferably aluminum alloy containing magnesium.

The metal tray 16 or metal external plate 22 has sufficient rigidity to ensure good mechanical protection.

Since metal is a good conductor, when the component 4 is placed on a flat internal face 8 of the tray 4, it is not necessary to apply a conduction element such as thermal paste.

In particular, aluminum alloy containing magnesium provides good machinability for producing complex elements and good resistance to creep at high temperature, compared to conventional aluminum.

Alternatively, the tray 16 is based on a composite or plastic.

This makes the tray 16 more lightweight while maintaining optimal mechanical characteristics.

The tray 16 is produced by stamping.

This manufacturing technique is suitable for forming the tray 16, the bottom wall 18 and side wall 20 of which are made in one piece.

Alternatively, the external plate 22 is based on a composite or plastic.

This makes the plate 22 more lightweight while maintaining optimal mechanical characteristics.

The composite comprises a polymer matrix loaded with reinforcing elements such as carbon or glass fibers.

The polymer matrix is a thermoplastic such as ABS, PMMA, PE, PVC, PET, PP, PVC.

The plastic is a thermoplastic such as ABS, PMMA, PE, PVC, PET, PP, PVC.

Provision can be made for the external assembly face 24 to be made of metal and the external plate 22 made of plastic, being in particular a polymer-based composite.

Provision can be made for the external assembly face 24 to be made of metal and the external plate 22 made of metal.

Provision can be made for the external assembly face 24 and/or the external plate 22 to be made of aluminum, preferably aluminum alloy containing magnesium.

The assembly of the external plate 22 and the external assembly face 24 is carried out by a method selected from adhesive bonding, welding, rolling and riveting.

In particular, welding and adhesive bonding have the advantage of not affecting the rigidity of the materials to be assembled.

Advantageously, the welding method is MIG (metal inert gas)-MAG (metal active gas) welding.

The welding method is laser welding.

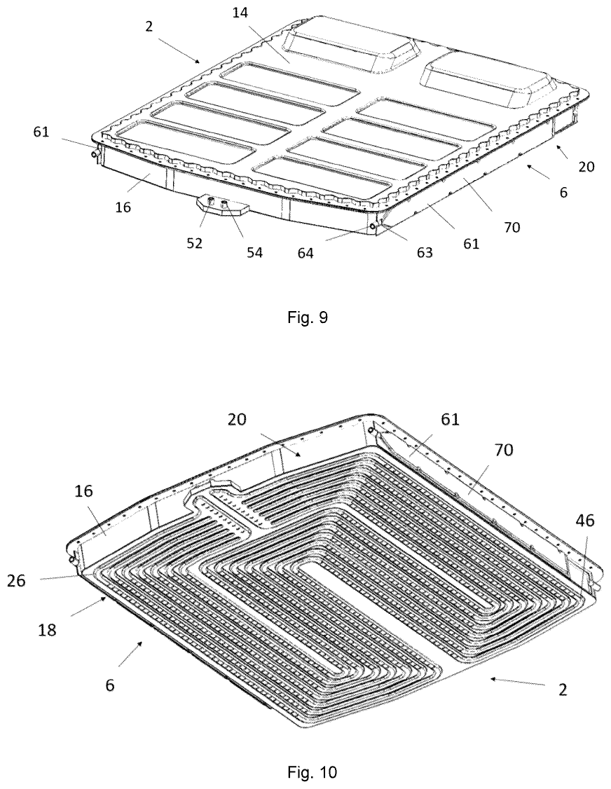

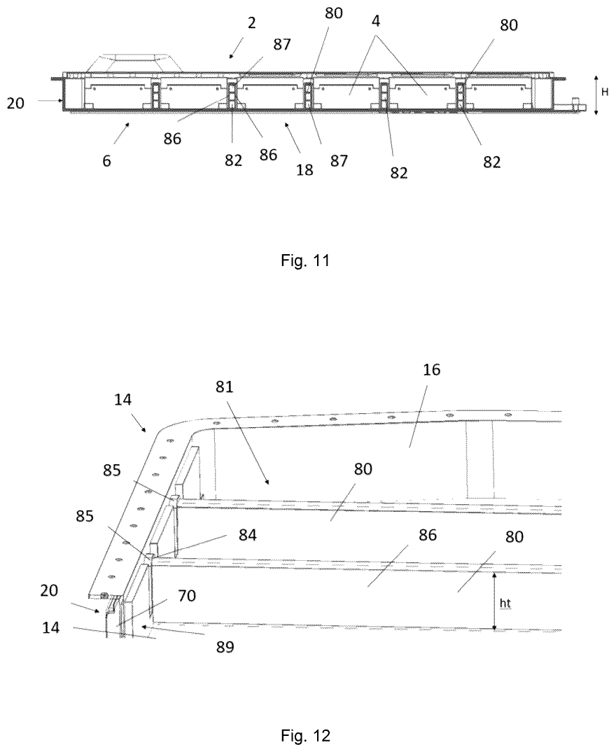

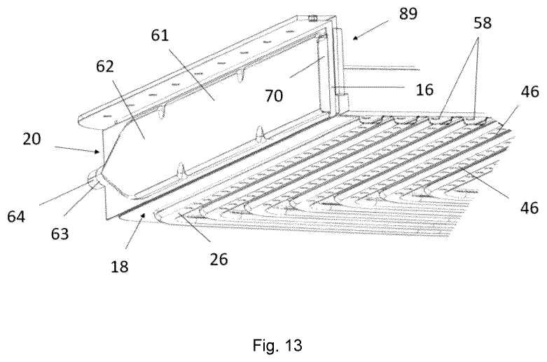

FIGS. 9, 10, 11, 12 and 13 show the compartment 6 comprising the side wall 20 which is provided with at least one heat transfer fluid circulation area 70 and the compartment 6 comprising at least one tube 80 comprising at least one circulation fluid flow channel 82, this tube 80 being in fluidic communication with the heat transfer fluid circulation area 70 of the side wall 20 and extending in an interior space 81 of the compartment 6, in particular between two places for components 4.

In the example described in particular in FIGS. 9 to 13, the compartment 6 receives two rows of six modules, such that a total of twelve modules are housed in this compartment 6. Each module can be secured in the compartment 6 using securing elements such as screws (not shown). Each module has a rectangular perimeter.

The compartment 6 comprises:
a bottom wall 18 arranged to receive the components 4,
a side wall 20 connecting to the bottom wall 18 and provided with two heat transfer fluid circulation areas 70,
tubes 80 each comprising parallel circulation fluid flow channels 82, these tubes 80 being in fluidic communication, at their ends, with the heat transfer fluid circulation areas 70 of the side wall 20.

The tubes 80 extend in an interior space 81 of the compartment 6, between places for components 4.

The side wall 20, which forms a perimeter of the compartment 6, comprises slots 84 each arranged to receive, sealingly, one end of one of the tubes 80 in such a way as to provide the fluidic communication between the tube 80 and the corresponding heat transfer fluid circulation area 70. This slot 84, facing the inside of the compartment 6, has an elongate shape along the height H of the compartment 6.

Each slot 84 is bordered by an annular collar 85 which bears, sealingly, on a portion of the tube 80, as can be clearly seen in FIG. 12.

Each tube 80 has two parallel flat main faces 86. Its height ht is greater than half the height H of the side wall 20 and less than the height H of the side wall.

Each tube 80 is straight and comprises several internal longitudinal cavities 87 for the flow of heat transfer fluid, defining the plurality of channels 82.

The side wall 20 comprises two opposite faces 89, which are parallel, and the tubes 80 extend between these two opposite edges 89.

In the example described, the compartment 6 comprises two heat transfer fluid circulation areas 70, one of the areas 70 being an area where fluid enters the tube(s) and the other of the areas 70 being a fluid outlet area for discharging the fluid that has circulated in the tubes 80.

These two areas 70 are on two opposite faces 89 of the compartment 6.

The tubes 80 are arranged parallel.

The side wall 20 is provided with two rows of slots 84, on the two opposite faces 89 of the side wall 20, each tube 80 interacting with two opposite slots 84.

These tubes 80, of identical length, are placed between places for receiving the components 4 to be cooled.

Thus, on either side of the tubes 80, there are components 4 to be cooled.

The tubes 80 are arranged perpendicular to the fluid circulation areas 70.

The tubes 80 are profile sections, made of aluminum or steel.

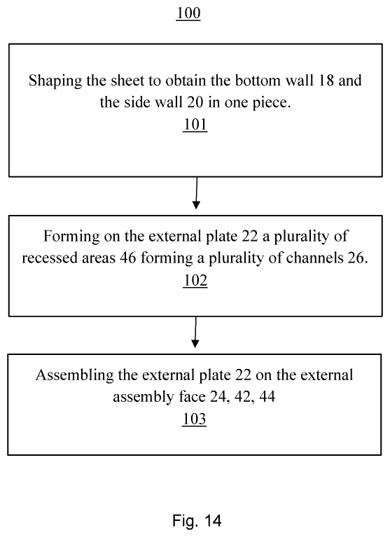

The invention also relates to a method for manufacturing the compartment 6 (shown in FIG. 14), comprising the following step:
shaping 101 a sheet to obtain the bottom wall 18 and the side wall 20 in one piece.

Thus, the bottom wall 18 and the side wall 20 of the tray 16 are made in one piece.

The bottom wall 18 and the side wall 20 being made of metal, the method 100 comprises the following step:
shaping the sheet which is made of metal, by stamping, to obtain the bottom wall 18 and the side wall 20 in one piece.

The method 100 comprises a step of forming 102 on the external plate 22 a plurality of recessed areas 46 forming seven circulation channels 26 parallel to one another.

The method 100 comprises a step of forming flat junction areas 48 between the recessed areas 46.

The method 100 comprises a step of assembling 103 the external plate 22 on the external assembly face 24, this assembly step being carried out by adhesive bonding, welding, rolling or riveting.

In particular, welding and adhesive bonding have the advantage of not affecting the rigidity of the materials to be assembled.

For the method 100 for manufacturing the compartment, the assembly step is carried out by MIG (metal inert gas)-MAG (metal active gas) welding.

This method 100 is particularly effective for optimizing the welding interface between the external plate 22 and the external assembly face 24.

Alternatively, the assembly step is preceded by chemical attack or texturing of the external assembly face 24 and/or the flat junction areas 48 of the external plate 22.

### PARTS LIST

2: assembly
4: component
6: compartment
8: internal face of the bottom wall
10: internal face of the side wall
12: screw
14: cover
16: tray
18: bottom wall
20: side wall
22: external plate
24: external assembly face on the bottom wall
26: circulation channel(s)
30: main plane of the cover
31: recessed protrusion
32: rim
34: hole
36: recess on the internal face of the side wall
38: tab
42: external face of the cover
44: external face of the side wall
46: recessed area on the external plate
48: flat junction area
50: straight edge on the recessed area
52: fluid inlet
54: fluid outlet
56: ledge
58: disrupting element
61: lateral external plate
62: flat main face
63: orifice
64: end piece
70: circulation area of the side wall
80: tube
81: interior space
82: channel of the tube
84: slots
85: annular collar
86: flat main faces
87: internal longitudinal cavities
89: opposite faces

What is claimed is:

1. A compartment arranged to receive a component capable of giving off heat during operation, comprising:
a cover;
a tray provided with a bottom wall on which the component can be placed and a side wall which is arranged to be assembled with the cover that closes the tray, the bottom wall and the side wall being in one piece; and
an external plate arranged to be assembled on an external assembly face belonging to the tray or to the cover, to form at least one circulation channel for a heat transfer fluid.

2. The compartment as claimed in claim 1, wherein the bottom wall includes a flat internal face on which the component may be placed.

3. The compartment as claimed in claim 1, wherein the external assembly face is on the bottom wall or on the side wall or on the cover.

4. The compartment as claimed in claim 1, wherein, when the external plate is on the external assembly face, this external assembly face is arranged to allow heat exchange between the component and the heat transfer fluid.

5. The compartment as claimed in claim 1, wherein each channel is formed by the external assembly face and the external plate which each define a portion of the transverse perimeter of the channel.

6. The compartment as claimed in claim 1, wherein the external plate includes a plurality of recessed areas forming a plurality of channels, for example two circulation channels parallel to one another.

7. The compartment as claimed in claim 1, wherein the external plate includes flat junction areas arranged to be pressed against the external assembly face to form the circulation channel(s).

8. The compartment as claimed in claim 1, wherein the side wall is provided with at least one heat transfer fluid circulation area and the compartment comprises at least one tube including at least one circulation fluid flow channel, the at least one tube being in fluidic communication with the heat transfer fluid circulation area of the side wall and extending in an interior space of the compartment.

9. An assembly comprising at least one component capable of giving off heat during operation, and a compartment including:
a cover;
a tray provided with a bottom wall on which the component can be placed and a side wall which is arranged to be assembled with the cover that closes the tray, the bottom wall and the side wall being in one piece; and
an external plate arranged to be assembled on an external assembly face belonging to the tray or to the cover, to form at least one circulation channel for a heat transfer fluid,
wherein the compartment is arranged to exchange heat with the component placed on an internal face of the compartment.

10. A method for manufacturing a compartment including
a cover;
a tray provided with a bottom wall on which the component can be placed and a side wall which is arranged to be assembled with the cover that closes the tray, the bottom wall and the side wall being in one piece; and
an external plate arranged to be assembled on an external assembly face belonging to the tray or to the cover, to form at least one circulation channel for a heat transfer fluid,
wherein the method comprises:
shaping a sheet to obtain the bottom wall and the side wall in one piece.

11. The manufacturing method as claimed in claim 10, wherein the sheet, the bottom wall and the side wall are made of metal, wherein the shaping is done by stamping.

12. The manufacturing method as claimed in claim 10, further comprising forming on the external plate a plurality of recessed areas forming a plurality of channels.

13. The manufacturing method as claimed in claim 10, further comprising assembling the external plate on the external assembly face, this assembly step being carried out by adhesive bonding, welding, rolling or riveting.

14. The manufacturing method as claimed in claim 13, wherein the assembly step is carried out by MIG (metal inert gas)-MAG (metal active gas) welding.

15. The manufacturing method as claimed in claim 13, wherein the assembly step is preceded by chemical attack or texturing of the external assembly face and/or the flat junction areas of the external plate.
